(19) United States
(12) Patent Application Publication
(10) Pub. No.: US 2008/0263130 A1
(43) Pub. Date: Oct. 23, 2008

(54) APPARATUS, SYSTEM AND METHOD OF DIGITAL CONTENT DISTRIBUTION

(76) Inventors: Nir MICHALOWITZ, Caesaria (IL); Sara Bitan-Erlich, Hadar-Am (IL); Ronen Hod, Shoham (IL); Itamar Gilad, Kiryat Haim (IL); Yechiam Yemini, Fort Lee, NJ (US); Amit Shaked, Netanya (IL); Roni Rosen, Ramat Gan (IL); Baruch Even, Netanya (IL); Rennen Hallak, Omer (IL)

Correspondence Address: Pearl Cohen Zedek Latzer, LLP, 1500 Broadway, 12th Floor, New York, NY, 10036, US

(21) Appl. No.: 12/047,870

(22) Filed: Mar. 13, 2008

Related U.S. Application Data
(60) Provisional application No. 60/907,911, filed on Apr. 23, 2007.

(51) Int. Cl. G06F 15/16

(52) U.S. Cl. 709/202

(57) ABSTRACT

A system and apparatus for content delivery to storage. Delivery may be performed according to content types, which may be, for example, content object identifier, a flow of content objects, and store channel levels. Delivery may be performed according to a virtual network defined over a physical network infrastructure and further using peer-to-peer, multicast and/or unicast protocols.

### CROSS REFERENCE TO RELATED APPLICATIONS

This application claims the benefit of U.S. Provisional Patent Application No. 60/907,911, filed on Apr. 23, 2007, which is incorporated in its entirety herein by reference.

### FIELD OF THE INVENTION

This invention relates to the field of Content Distribution Networks (CDN) and, in particular, to methods and systems of content distribution and delivery.

### BACKGROUND OF THE INVENTION

Evolution of the Internet has changed the client-server interaction scheme. In the Internet today, several approaches have been proposed for providing infrastructure, (typically at layers 4 through 7), to get content to end users or user agents in a scalable, reliable, and cost-effective fashion. Various protocols and appliances have been developed for the location, download, and usage tracking of content, examples of such technologies include: web caching proxies, content management tools, intelligent web switches and others.

The problem of increasing the scale, reach and performance of content networks (e.g. reliability of content delivery, response times, etc.) has been recognized in prior art and various systems have been developed to provide solutions, for example:

U.S. Patent Application No. 2005/216,942 (Barton) entitled “Multicasting multimedia content distribution system” discloses a method and apparatus for a multicasting multimedia content distribution system. According to Patent Application No. 2005/216,942, a content server creates a schedule of transmission times for data streams and assigns the streams to multicast groups. DVRs receive the schedule from content server that contains content descriptions for each data stream along with the transmission times of each particular content description. The content server transmits the content across the Internet according to the published schedule via a multicast transmission designated for a particular multicast group. Each DVR determines the content for which it has an interest, finds the scheduled time for transmission for the content, schedules a recording time in its recording schedule, and joins the associated multicast group at the scheduled time. The DVR receives the multicast stream for the group and stores the stream on its local storage device for use by the DVR or for viewing by a user.

U.S. Patent Application No. 2006/248,201 (Benkert et al.) entitled “Communication system” discloses a server of a communication system having a broadcast communication network, a communication service server and a storage device. The server providing a plurality of media streams which can be transmitted in a service area of the broadcast communication network by the broadcast communication network. The server includes a determination device that interrogates parameter values from a storage device for each client situated in the service area, and receives data which are transmitted by the broadcast communication network, wherein the parameter values are used to determine which of the media streams are intended to be communicated to the respective client, and determines based on the parameter values which of the media streams are intended to be transmitted by the broadcast communication network in the service area. The server also includes a controller that controls the broadcast communication network such that the network transmits the media streams which are intended to be transmitted.

U.S. Patent Application No. 2006/253,444 (Lapolito et al.) entitled “Method and system for dynamically pre-positioning content in a network based detecting or predicting user presence” discloses a method, system and apparatus for dynamically pre-positioning content from servers located in a network, which may be a content distribution network. The content is pre-positioned on a proxy server, and the pre-positioning is triggered by at least one of the scheduling of an event and the presence of a user. Users commuting between different locations of a company can quickly and easily access the pre-positioned content. This content may be prioritized and pre-positioned, based on a user requiring a specific content at a particular time.

International Patent Application WO07/1,275 (Li et al.) entitled “Multicast downloading using path information” discloses downloading of content to a requesting client through content distribution network consisting of edge servers, where download occurs upon receiving a content request, a content server responses with a request-routing message that includes source data identifying the content and path data identifying a path through the network to a source of such content. Having the path information in request-routing message enables a requesting client to make the request to a particular edge server, which in turn can register the downloading request and access the content from an appropriate location, thereby obviating the frequent communication between the content server and edge servers on the path.

### SUMMARY OF THE INVENTION

In general, a content distribution network can be viewed as a virtual content overlay network in the OSI stack. The invention, in some of its aspects, is aimed to provide a novel solution facilitating content delivery based on a proposed granularity of service-oriented underlying elements: content object identifiers, flows of content objects, and/or store channels.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 depicts a high level block diagram of a CDS in accordance with certain embodiments of the present invention;

FIG. 2 depicts a block diagram of an Interface Socket (IS) in accordance with certain embodiments of the present invention;

FIG. 3 depicts a an exemplary CDG in accordance with certain embodiments of the present invention;

FIG. 4 depicts an exemplary u-link in accordance with certain embodiments of the present invention;

FIG. 5 depicts an exemplary m-link in accordance with certain embodiments of the present invention;

FIG. 6 depicts an exemplary p-link in accordance with certain embodiments of the present invention; and

FIG. 7 depicts an exemplary algorithm in accordance with certain embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EXEMPLARY EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

The references cited in the background teach many principles of volume rendering that are applicable to the present invention. Therefore the full contents of these publications are incorporated by reference herein where appropriate for appropriate teachings of additional or alternative details, features and/or technical background.

For the sake of clarity and in ambiguity, a glossary of terms used in the discussion below is provided next.

The term “content provider” used in this patent specification should be expansively construed to include any entity or body who owns and provides the content (e.g. Disney, Virgin, Barnes & Noble, etc).

The term “distributor,” used in this patent specification should be expansively construed to include any entity or body who owns the distribution platform, e.g. a CDN, and who further distributes content and/or advertisements to consumers.

The term “user” used in this patent specification should be expansively construed to include any entity or person who consumes the content and the advertisements.

The term “personal storage” used in this patent specification should be expansively construed to include any platform or part thereof facilitating a keeping of certain content in full user's custody, including storage platforms directly connected to a home network, portable storage platforms, off-line storage devices and other personal storage platforms. A personal storage may be capable of obtaining data from an external network. A personal storage may further be incorporated as part of a PC, or as a PC attachment. A personal storage may incorporated in a mobile device (e.g. cellular phone, palm-top computer, media player, etc.), a digital video recorder (DVR), a set top box, an electronic game system, TV set. A personal storage may be a network attached storage (NAS) appliance connected to a home network. A personal storage may be provided as an independent network-enabled storage system, etc.

The term “content object” used in this patent specification should be expansively construed to include any type of digital information that may be stored, communicated, executed or otherwise manipulated by a computer, e.g. movies, applications, games, files, etc., associated with certain content source, e.g. a web page, a set of pages, or a refresh of a web-site in storage, and handled by a CDN as one logical unit. Switching/routing content objects is referred to hereinafter as switching/routing content related data on a content object level of granularity.

The term “content unit” is used in this application to denote a basic delivery unit (which may be smaller than content object) transmitted by a virtual link. Depending on the type of the link, a content object may be divided differently into content units. We assume that a content unit is always either fully received or not received at all (i.e. parts of content units are not received).

The term “content flow” or “flow” used in this patent specification should be expansively construed to include any sequence of content objects handled by CDN as one logical entity and characterized by a storage source (and, optionally, redundant sources) and multiple storage destinations. Switching/routing content flows is referred hereinafter as switching/routing content related data on a content flow level of granularity.

The term “store channel” (SC) used in this patent specification should be expansively construed to include any set of flows, where a set may be characterized by certain criteria related to and/or defined by the provider of the channel and/or flows thereof. For example, a store channel may be a particular episode of a television series and the provider might be a particular publisher. Another example of a SC may be parts of, or the entire content comprising a television channel. A SC may be characterized by dynamic sets containing one or more storage sources and by dynamic sets containing certain one or more storage destinations. Switching/routing store channels is referred to hereinafter as switching/routing content related data on a store channel level of granularity.

The term “content distribution switch” (CDS) used in this patent specification should be expansively construed to include any types of switches capable to switch and/or route content related data in accordance with information related to at least one of levels 4-7 in the (Open Systems Interconnect) OSI stack.

The term “content distribution overlay” (CDO) used in this patent specification should be expansively construed to include two or more content distribution switches connected by virtual links and configured to support at least one interface with an external network.

In accordance with certain aspects of the present invention, there is provided a content distribution switch, content distribution overlay and method of content distribution capable of switching/routing content related data at one or more levels of granularity selected from the group comprising content object, content flow and store channel levels.

In accordance with further aspects of the present invention, the CDS may be protocol independent, and scalable. A CDS may comprise at least one ingress and at least one egress interfaces configured to support at least one of transfer mechanisms selected from the group comprising unicast, multicast, and peer-to-peer virtual link transfer protocols.

A CDS may be configured to support at least one virtual link selected from a group comprising m-link, u-link and p-link.

A u-link may connect a single source CDS to a single destination CDS; a content unit (object) placed by the source CDS on a u-link, may be delivered to the destination (such communication scheme may be termed a unicast).

An m-link may be a virtual link connecting a single source CDS to multiple destination CDSs. Each subset of the destinations group may correspond to one or more m-link addresses, e.g. if an m-link has n destination, then one or more m-link addresses can be assigned each one of the 2′-1 subsets of destinations. In practice, the number of m-link addresses might be limited by the physical properties of the link, e.g. the number of multicast groups used by the device realizing the multicast. Any subset of the group of destinations of an m-link may be associated with one or more address, and any m-link destination may listen on several m-link addresses. A CDS belonging to the m-link destinations may join any of the m-link address, and receive content objects destined to one or more of these addresses. When the source CDS is placing a single copy of a content unit (object) and an address on an m-link, the m-link may transmit the content unit (object) (flow) to all the destinations in the appropriate subset (such communication scheme may be termed a multicast). An m-link may comprise broadcast address, which is associated with all destinations contained in the m-link.

A p-link may connect a group of CDSs. A content object placed on a p-link by a CDS belonging to the p-link may be received by all other CDSs in the group, which communication scheme may be referred to herein as a pcast. There are several differences between p-link and m-link, for example, an m-link transmission of individual data elements (content unit) may typically be done from a single source to a single destination, whereas in a p-link, several transmissions between sender/receiver pairs may occur simultaneously One difference between a p-link and an m-link may be that in an m-link only one CDS (the source CDS) may transmit content objects to all the others, while in a p-link, each CDS connected by the p-link may serve as a source and a destination, sometimes simultaneously, possibly of different content units.

Operation of a CDO may be controlled by policy, which may be distributed or central. Depending on the policy, a virtual link may be reliable or un-reliable, connection oriented or connectionless. Virtual links may be protocol independent, and the underlying egress/ingress links may use an open range of unicast/multicast/peer-to-peer link transfer protocols and mechanisms (e.g. IPv4 (unicast/multicast), IPSEC, UDP, TCP, RTSP, 802.xx, MPLS, HTTP, FTP, NFS, CIFS, ATA, USB, BitTorrent).

In accordance with further aspects of the present invention, a SC's traffic may be routed along a CDG (Content Distribution Graph). A CDG may be a directed graph, where the CDSs may be the vertices, and the virtual links may be the edges. Each CDG may correspond to a single SC, and may further contain a collection of directed routes from the SC source CDSs (which will be referred to as SC roots hereafter) to the SC destination CDSs (which will be referred to as SC sinks hereafter). The SC sources may all be the vertices in the CDG whose incoming degree is zero (i.e. don't have incoming edges), and the SC sinks are all the vertices in the CDG whose outgoing degree is zero (i.e. don't have outgoing edges). According to embodiments of the invention, SC sinks (which may be CDSs) may reside at an end-user's premises, e.g. a user's PC. Content objects might further be distributed to consumption peripherals connected to a user's PC functioning as an SC sink (e.g. TV screen, LCD monitor etc.). In accordance with further aspects of the present invention, CDG topology may be dynamic, for example, CDSs may join or leave a CDG according to configuration messages they may receive.

In accordance with further aspects of the present invention, the content may be distributed to an end-user's personal storage. A CDS operatively coupled to (or comprising) a personal storage may be configured to enable and/or support manipulation of individual content objects, flows of content objects and store channels directly at the end user's personal storage. According to embodiments of the invention, a CDO may be configured to support content distribution to a personal storage.

A CDO may be viewed as a unification of all CDGs corresponding to SCs supported by the CDO.

A CDS may switch SC flows from ingress interfaces to respective egress interfaces, according to a FDB (Forwarding DataBase). A FDB may represent a CDO (i.e. the collection of CDGs) the CDS belongs to. A FDB may contain, for each SC and each ingress interface, the list of egress interfaces to which traffic is to be forwarded. A CDS might belong to multiple CDOs, in which case the FBD may contain entries for all the SCs from all the CDOs the CDS belongs to. Each CDS may have a unique identity of the form <CDO_ID, CDS_ID> that may be used to distinguish it from other CDSs in the CDOs it belongs to, and/or other CDOs.

In accordance with further aspects of the present invention, a CDO may contain one special control CDG, which may include all CDSs in the CDO. Such control CDG may be constructed by an entity which is external to the CDO. A control CDG may be used to transmit control information, including, for example, messages used in a construction of a CDG.

A CDS may be configured to support one or more of a number of operations and features. Some embodiments of the invention may forward content from ingress interface to single/multiple egress interfaces, according to a forwarding data base (FDB). According to embodiments of the invention, a content object or unit may be buffered in a CDS local storage. Some embodiments of the invention may include provisioning/maintenance of CDGs, and CDGs may be reflected in FDB entries. According to embodiments of the invention, CDSs may update FDBs entries to reflect CDGs updates.

Some embodiments of the invention may provide for flexible scheduling. Competing traffic of the same or different SCs may be scheduled (and buffered) by a CDS possibly in order to reflect priorities and arrival deadlines of content objects in the SC. Scheduling may select the set of active transfers at any given moment in order to maximize the amount of data distributed by the CDO. According to embodiments of the invention, scheduling may take into account parameters such as, but not limited to, the various lines capacities, content arrival deadlines, priorities, and CDSs requests, which might be a parameters of preferences, automatic or manual selections. In some embodiments of the invention, scheduling may be personalized, whether manually or automatically, based on preferences, viewing habits, characteristics, etc. of a particular user.

Embodiments of the invention may be provide for resiliency. According to embodiments of the invention, a CDS may handle link loss and throughput changes. According to embodiments of the invention, loss of nodes may be handled by reconstructing CDGs, for example to switch between alternate sources. According to embodiments of the invention, resiliency may be supported by a receiving CDS by aborting content object receive, or by a sending CDS by adjusting traffic schedules according to dynamic changes.

Embodiments of the invention may provide for reliability. For example, a CDS may handle packet loss and out of order packets. Such handling may be accomplished by utilizing protocols such as transmission control protocol (TCP), or by using forward error correction (FEC).

Embodiments of the invention may employ policy-based routing. According to embodiments of the invention, a CDS may update entries in a FDB according to policy rules.

Embodiments of the invention may employ traffic shaping/policing. According to embodiments of the invention, a CDS may manage traffic, for example, in order to avoid congestion or overloading of network segments.

Embodiments of the invention may employ multi-domain operations. According to embodiments of the invention, links may cross autonomous systems and/or admin domains. A CDS may handle tasks such as handshaking required in order to communicate traffic across autonomous systems and/or admin domains. Some embodiments of the invention may provide for multi-CDO operations. According to embodiments of the invention, a single CDS may be associated with multiple CDOs.

In some embodiments of the invention, content distribution may be made directly to an end user personal storage, while adhering to user's bandwidth limitation.

Finally, according to embodiments of the invention, CDOs and the CDSs may distribute content to intermediate as well as end user personal storage. Such storage may be operatively coupled to respective CDS or it may a part thereof. The storage may be a part of the CDO and/or a part of an external network interfacing the CDO.

Among advantages of certain aspects of the present invention are higher quality of resiliency, and reliability. For example, if a CDS link failed, the CDS may assemble a content object or even a flow in local storage and transmit it when the link is restored, for example, based on the partial transmission of one or more content units into which a content object may have been divided. In such situations, according to embodiments of the present invention, a receiving CDS may assemble a content object using the content units.

Among other possible advantages is the maximization of the amount of data distributed to end user, while using limited network resources (defined by policy). For example, scheduling of transfer on a single m-link of several flows belonging to different SCs may take into account at least one parameter relating to the network resource availability. Such network resource availability parameters may include, for example, the SCs end-users bandwidth limitations and requests, the network's multicast limitations, e.g., the number of multicast addresses which may be handled simultaneously by the network, etc. Taking into account these or other network resource availability parameters may increase the amount of data bytes distributed to the SC end users (i.e. the CDG sinks) over time, while possibly adhering to deadlines and priorities requirements.

Embodiments of the invention may support and/or enable personalization and/or distribution. For example, a request for content of a destination or sink CDS may be a result of a user's explicit requests (for example, a result of subscription), a policy of the (e.g., “catch up TV” which generates one request per day), or a result of personalization by a learning engine. Accordingly, a request generated by an end user may influence the content in all the CDSs comprising the CDG.

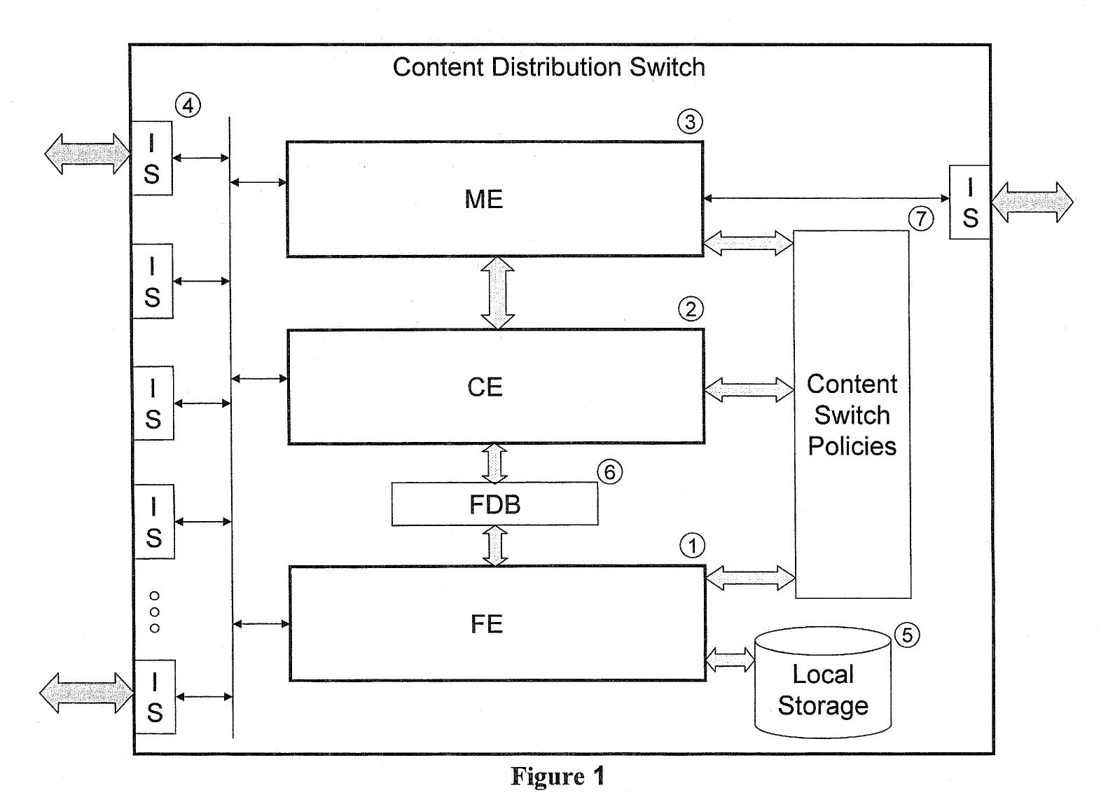

Reference is made to FIG. 1 showing a schematic, exemplary block diagram of a CDS according to embodiments of the invention. According to embodiments of the invention, a CDS may comprise three engines, a forwarding engine—FE 1, which forwards flows along a CDG from ingress links to egress links, a control engine—CE 2, which maintains the CDGs and the FDBs, and a management engine—ME 3, which configures and monitors the CDS, CDGs and flows. Multiple Interface Sockets—(IS) 4, local storage 5, forwarding database—FDB 6, and content switch policies DB 7.

Note that, according to embodiments of the invention, an end customer machine may be considered a CDS, although its FE might not have full functionality.

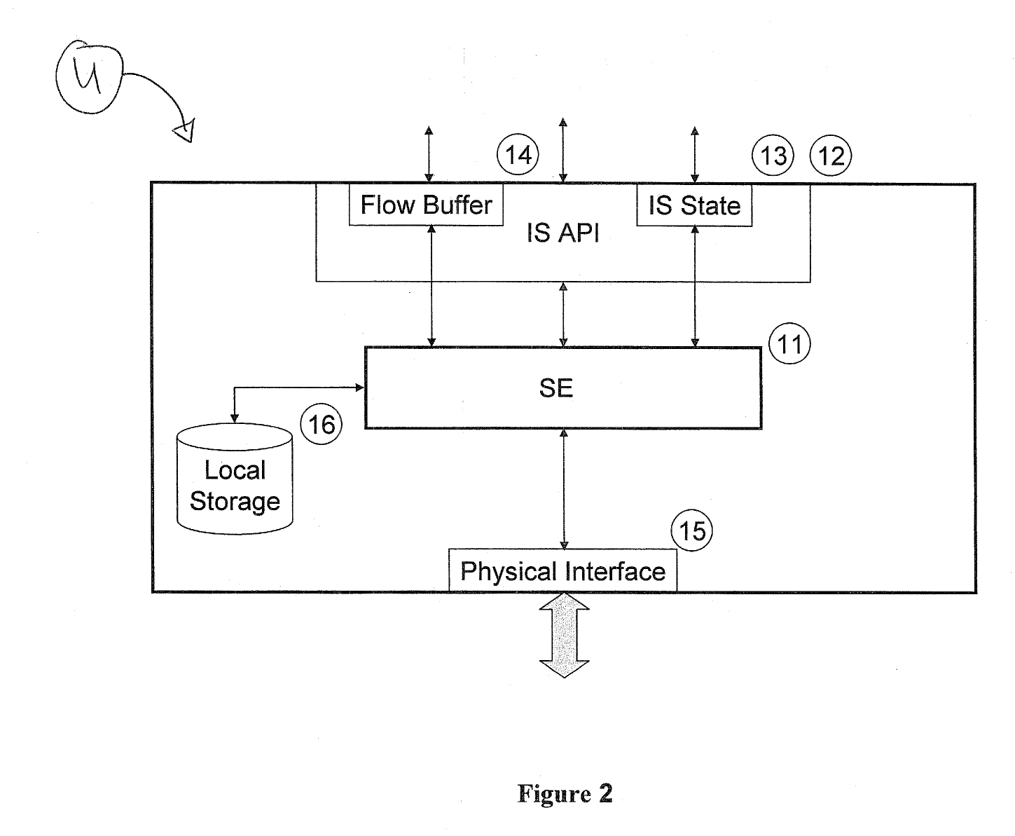

Reference is additionally made to FIG. 2 showing an exemplary block diagram of an IS according to embodiments of the invention. An IS may be viewed as an abstraction of the underlying link. An IS may consists of a SE (Socket Engine) 11 which may handle transmission reliability (e.g. partial content object loss detection, recovery, reordering etc.), and scheduling and I/O operation of physical interface 15. Physical interface 15 may be a network interface card (NIC), but may also be a storage interface, e.g. flash or hard disk interface, a DVD interface or any other suitable storage or communication device or sub-system interface. IS 11 may interface with other CDS modules through IS application program interfaces (APIs) 12, which may further include flow buffer 14 and IS state module 13. Flow buffer 24 may contains the relevant part of the flow which is currently read/written from/to the IS. The IS may have its own local storage 16, which may be used to buffer content objects during scheduling and/or transmission. The operation of the SE 11 is further detailed below under the description of the different links (m-link, u-link and p-link). Each IS may have a unique internal identity, which may be a number assigned by the CDS, and an external identity—<CDS identity∥ID internal identity>. According to embodiments of the invention, IS state module 13 may store, manage and report the state of IS 4. For example, reporting of arrival of new content or reporting that internal buffer 16 is filled to capacity, and, consequently, data for transmission cannot be accepted by IS 4.

According to embodiments of the invention, forwarding engine 1 may forward flows from ingress ISs to egress ISs based on information stored in FDB 6. Forwarding may further be executed by FE (1) reading from an ingress IS 4 flow buffer 14, and writing to an egress IS 4 flow buffer 14. FE 1 may store parts of a flow in local storage 5. For example, if the egress ISs are not available for forwarding (e.g. congested, offline or unavailable). FE 1 may also implement content switching according to information policies stored in content switching policies database 6. For example, a given SC or content object might not be allowed in a specific region, hence it may not be forwarded to a specific egress ISs.

According to embodiments of the invention, entries in the FDB may correspond to SCs. Each entry may contain an ingress IS identity I₀, and a list of egress IS identities {I₁, I₂, . . . , I₁}. For example, flows from an SC, arriving to IS I₀ are forwarded to each of {I₁, I₂, . . . , I₁}. According to embodiments of the invention, the FDB may be constructed, updated and maintained by CE 2.

According to embodiments of the invention, ME 3 may allow a local or remote administrator or user to configure and monitor various parameters concerning a CDS's operation. For example, the IS (physical) addresses may be retrieved, or the protocols used on a specific link may be changed or the amount of traffic passing through a specific IS may be configured or content switch policy database may be updated.

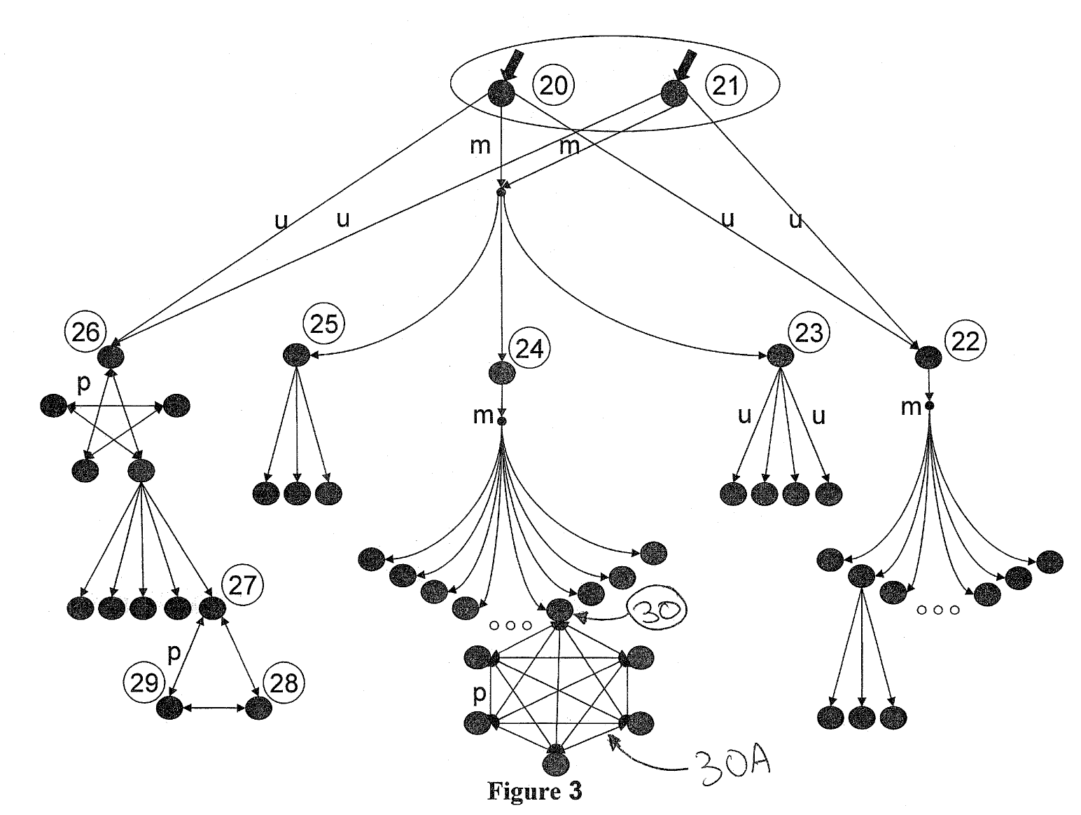

Reference is made to FIG. 3 which depicts an example CDG. Such CDG may correspond to a specific SC. The vertices (e.g. 22, 23, 24) shown in the graph are CDSs, and they are connected by virtual links which are the edges in the graph. According to embodiments of the invention, flows of content objects are placed by the content provider on special root CDSs 21 and 22 (denoted by an arrows), and may be forwarded to all CDSs in the CDG. A root CDS may be a CDS through which SCs are loaded into the CDG. According to embodiments of the invention, and as shown in the figure, a CDG may have more than one root. According to embodiments of the invention, two roots may exist in order to increase resiliency, other configurations, where multiple roots exist for purposes other than resiliency may also exist.

Three types of virtual links in a CDG are shown in FIG. 3: u-links, m-links and p-link virtual links. In FIG. 3 they are marked with the letters u, m and p respectively. For example, CDSs (20) and (21) (which, with respect to one another may be redundant) are connected by u-links to CDSs (22) and (26), and by m-links to CDSs (23), (24) and (25). CDSs (27), (28) and (29) are inter-connected by p-links.

According to embodiments of the invention, resiliency and fail-over may be supported through the use of redundant CDSs in a cluster, for example, CDSs 21 and 22 may form a cluster. According to embodiments of the invention, CDSs sharing a cluster may also share one or more network addresses, consequently, all CDSs in a cluster may receive the same communicated content. According to embodiments of the invention, a single CDS in a cluster may be designated as the primary CDS, the primary CDS may actually communicate received content to its destination while other (secondary) CDSs comprising the cluster may only store the received content. According to embodiments of the invention, when a primary CDS completes transmission of a content it may signal all other CDSs in the cluster, possibly identifying the content that was communicated. According to embodiments of the invention, an identifier may be associated with a content object, a content flow and/or a store channel. Consequently, all other CDSs in the cluster may release the stored content from their respective buffers. Alternatively, if the primary CDS fails to communicate the received content, one of the secondary CDSs in the cluster may assume the role of a primary CDS and communicate the content, possibly picking up transmission from the point where it was stopped or interrupted.

According to embodiments of the invention, CDSs in a cluster may run a dynamic fail over protocol, which may support automatic switch-over when the primary CDS falls or comes up again; in some cases switch over might be implemented manually. Protocols for dynamic fail over exist in the literature and may further be used by the present invention. According to embodiments of the invention, a source CDS may be connected to a cluster over a p-link, a u-link and/or an m-link.

According to embodiments of the invention, CDSs comprising a cluster may employ failover protocols as known in the art in order to detect a primary CDS in the cluster as well as in order to replace a failing primary CDS.

According to embodiments of the invention, virtual links may be implemented by different physical links, running variety of network, storage and application protocols. Physical links examples may be Ethernet, 802.11, GSM, Satellite, Flash disk, Fiber-Channel; network layer protocols: IP unicast, IP multicast, iSCSI. application level protocol examples may be FTP, HTTP or BitTorret.

According to embodiments of the invention, the properties of the physical links implementing the u-link, p-link or m-link are not necessarily exposed to the CDS engines (CE, ME & FE). The IS may provide an abstraction of the physical link and the protocols. The IS API (12) may expose to upper layers parameters such as, but not limited to, the link type (u-link, m-link or p-link), the IS states, the flow buffer, and the IS physical address(s). Depending on the link's type it may further expose additional parameters (e.g. an m-link will expose to the source the multicast addresses accessible by this link).

According to embodiments of the invention, a CDS may act as a P2P seed. As known in the art, a P2P seed is an initial content object to be distributed in a P2P network. Accordingly, a node sharing a seed, namely, enabling other nodes to download the seed, is referred to as a seeder. Typically, a seeder node on a P2P network posses an entire content object that may be downloaded by other nodes. For example, CDS 30 in FIG. 3 may receive content, for example from node 24, possibly according to a multicast communication protocol. Node 30 may further act as a seeder for P2P network 30A. It should be noted that a CDS may act as a gateway between networks that employ different communication protocols. For example, a CDS may connect a multicast network to a P2P network or a P2P network to a unicast network. According to embodiments of the invention, a CDS may simultaneously provide a specific content object to a plurality of receiving nodes using a plurality of communication protocols, e.g. P2P and unicast. It will be understood that in the context of the present application, the terms communication protocol and transmission protocol are used to refer to communication or transmission protocol at the level of a virtual link, and not at the physical layer link.

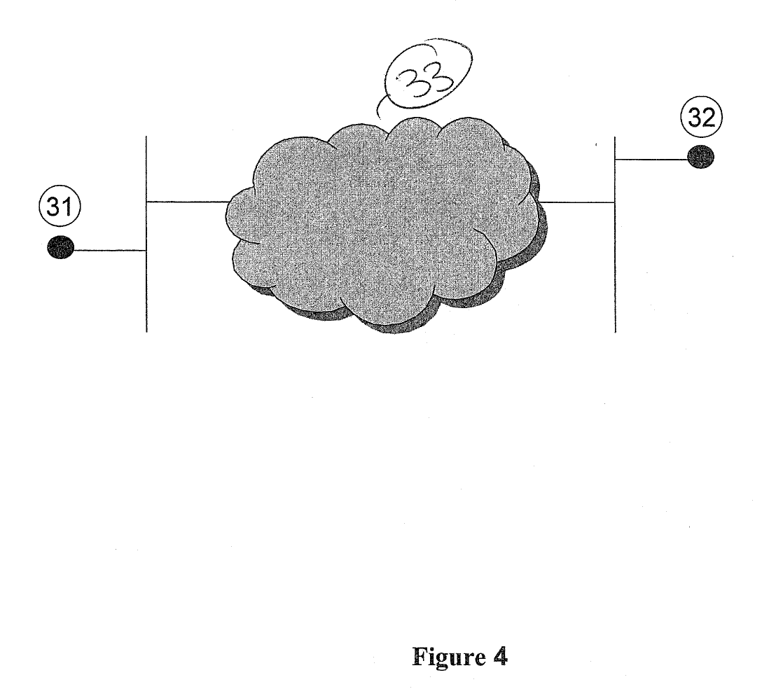

Reference is made to FIG. 4 depicting a possible configuration of two CDSs connected by a u-link. CDS 31 and CDS 32 may be connected to network 33, which may enable them to communicate. Network 33 may be the Internet, a cellular network; a satellite broadcast network or other. Network 33 may be an IP or a non-IP network. A u-link connecting CDS 31 and CDS 32 may enable them to exchange information between themselves. Such u-link may be implemented by UDP over IP unicast, thus be unreliable and connection less, or it may be implemented by protocol such as FTP or HTTP, hence be reliable and connection oriented. A u-link may be directional, going from content source to content destination. Content transfer may be achieved by push (source initiated transfer) or by pull (destination initiated transfer). In both cases, the initiating CDS may be part of a cluster.

One of the issues possibly addressed by a CDO is scheduling of content objects and flows. Unlink traditional Content Distribution Networks (CDNs), where content is due in its final destination a short while after request for the content is received (e.g. in VOD), distribution to storage allows high flexibility in content objects delivery time. Many service models can exist in a CDO, among them service level agreement (SLA) between parties such as end-user and network operator/owner, or end-user and content provider, or content distributor and network owner. According to embodiments of the invention, in one possible model, the content provider signs an SLA with the content distributor. The SLA may specify, among other things, the time of arrival for each content object. The content provider may store the content objects in the SC on the root CDS at some time before the required arrival time (such time may be specified by the content distributor). Each content object may include the content itself, and meta-data, which may include, among other parameters, the required time of arrival.

According to embodiments of the invention, A CDS may comprise a set of constraints that limit its usage of outgoing bandwidth. Examples of such constrains may be: outgoing link bandwidth, destination incoming link bandwidth, constrains on bandwidth usage during various hours of the week/day (possibly placed by the network owner). These constraints may be maintained and managed by the ME 3, and may further be implemented by the CE 2. CE 2 may configure the ISs 4 accordingly. Scheduling in a CDS may be dome done per outgoing IS. At the IS level, scheduling may be implemented by the relevant SE 11. According to embodiments of the invention, different scheduling algorithms may be used according to, for example, the type of the outgoing link (e.g. u-link, m-link or p-link).

According to embodiments of the invention, if a u-link is used, then several algorithms may be used in order to guarantee content object's time of arrival. For example, the CE may calculate per SC the longest path to destination CDS (using standard graph algorithms), subtract estimated path traversal time from SC's content object's time of arrival, and schedule outgoing content objects on the IS with increasing order of the subtraction result.

According to embodiments of the invention, if the IS is configured to be reliable and session oriented, then it may be responsible for reliability and session maintenance. If the link is a u-link, then standard protocols may be used to achieve both properties (e.g. FTP, HTTP). If otherwise desired (e.g. implement a u-link using UDP), then standard methods may be used for reliability and session maintenance.

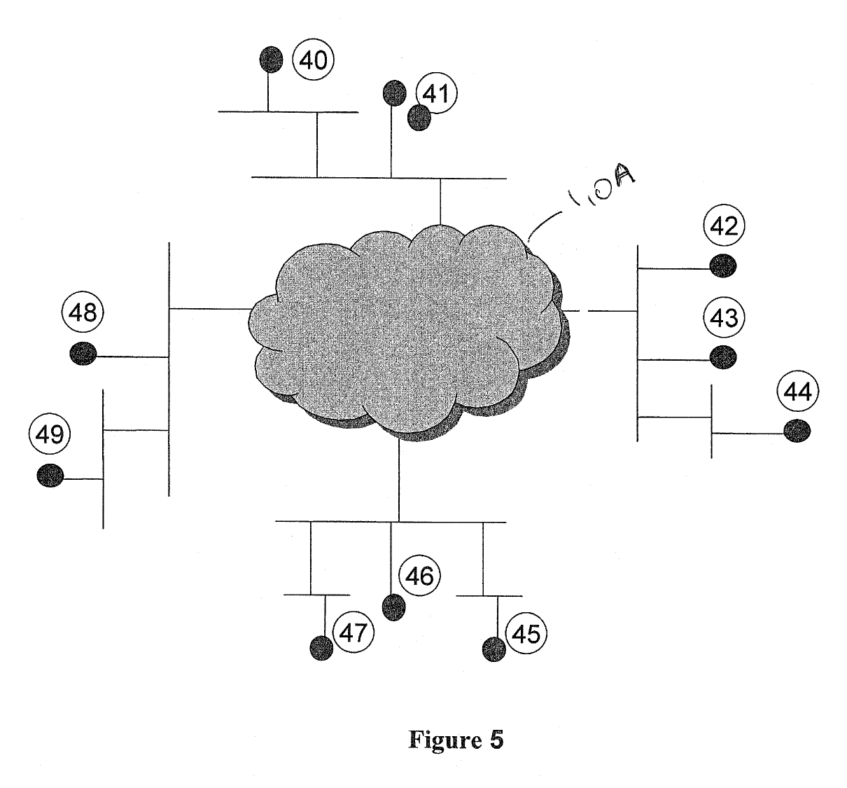

Reference is made to FIG. 5 which depicts an exemplary group of CDSs 40 through 49, connected by a p-link network 40A. According to embodiments of the invention, a peer-2-peer (p2p) protocol such as BitTorrent or eMule may be used to realize a p-link. In a p-link all CDSs may act both as source and as destination. Scheduling by ISs in p-links may be done similarly to scheduling in u-links. According to embodiments of the invention, reliability and session maintenance of a p-link may also be built-in p2p protocols.

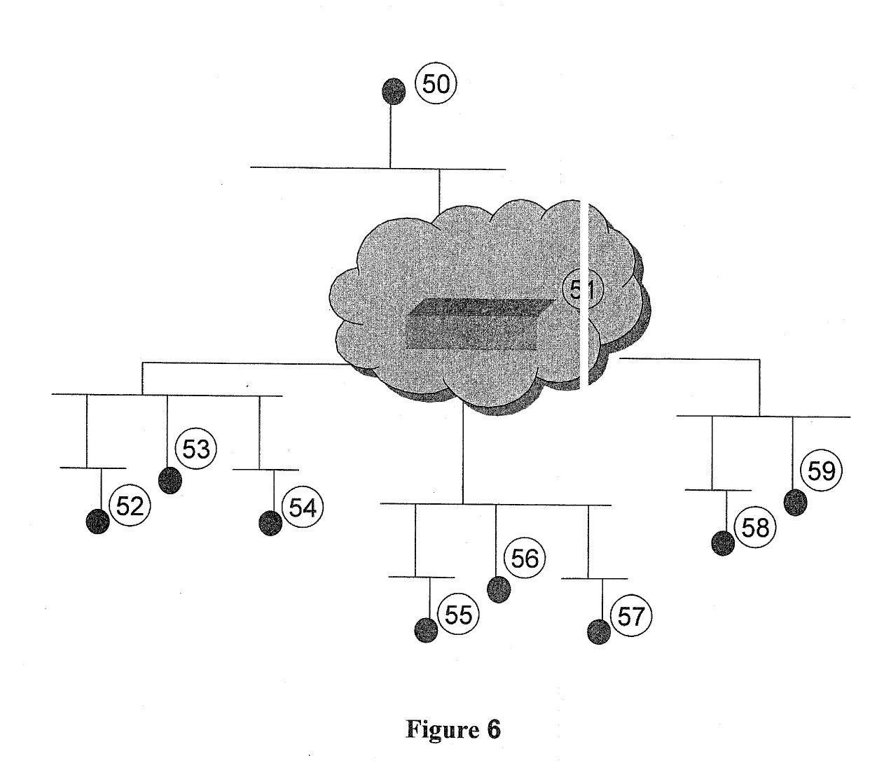

Reference is made to FIG. 6 which depicts an exemplary group of CDSs 52 through 59 connected by an m-link to a source CDS 50. According to embodiments of the invention, an m-link may be implemented by native multicast or tunneling depending on the underlying interfaced network. For example, in FIG. 6, CDS 50, which may be the source of the m-link, may generate, for example IP multicast traffic, which may be routed by the underlying (IP) network. If not all the networking device in the underlying network support IP multicast, then the traffic is likely to be dropped by intermediate device. According to embodiments of the invention, in order overcome such problems, CDS (50) may generate multicast traffic and further encapsulate (tunnel) it inside regular traffic supported by all the networking devices in the network (e.g. IP traffic). In FIG. 6, router 51 may support multicast, hence CDS (50) may tunnel traffic to router (51) (i.e., address of router 51 will appear as the destination address of traffic from CDS 50). This operation may be done by IS of CDS (50), and may be transparent to all destination CDS's as well as their respective ISs.

According to embodiments of the invention, an m-link content scheduling is configured to enable transmitting as much content as possible to all end users. However, some constraints associated with an m-link transmission must be addressed, these constraints may include: (1) the number of multicast groups the underlying network (e.g. a router comprising the path) can handle; (2) destination CDS capacity (note that the destination CDS might be an end user machine), including (a) the number of content objects a destination CDS can listen too simultaneously, (b) the amount of time per-day the destination CDS can receive content, and (c) the bandwidth that CDSs comprising the multicast group can handle; and (3) users' preferences, or the SC ratings, i.e. how destination CDSs are subscribed to each SC (hence should receive all the content objects from this SC).

According to embodiments of the invention, a CDS may commence communication of content according to a specific transmission protocol, for example, multicast, and at a later point in time, change the transmission protocol, namely, communicate the remainder of the content according to a different transmission protocol, for example, P2P. According to embodiments of the invention, a change in transmission protocol may be associated with various parameters and/or information. For example, multicast may be used when many nodes are interested in some specific content, however, if many nodes, or users associated with these nodes, choose to stop receiving that specific content and only a few nodes continue to receive the content then a CDS may communicate the remainder of the content in according to a unicast protocol. According to embodiments of the invention, a CDS may change the transmission protocol more then once during a communication of a single content object, flow or store channel. Other parameters that may affect a change of transmission protocol may be, the size of the content, an amount or ratio (e.g. percent) of the content already transmitted to destination nodes, a number of destination nodes receiving the content, the type of the content, any relevant metadata associated with the content, an available network bandwidth, various network utilization parameters, a delivery deadline of the content, a time of day, a date, a priority parameter associated with the content or priority parameter associated with at least some destination nodes receiving the content.

Another design constraint may be the minimizing of the uplink traffic—since potentially thousands destinations can be connected to a single m-link source, the source CDS can be easily flooded with feedback messages. The scheduling algorithm (like the reliability algorithm described afterwards) may avoid sending too many feedback messages to the source CDS.

Typically, the most critical resource in m-link scheduling is the number of multicast groups. According to embodiments of the invention, a scheduling algorithm may use the maximal number of multicast groups, and transmit content objects on each available multicast group, except one. According to embodiments of the invention, one specific (possibly constant) multicast address may be used as a signaling channel. Since usually the number of SCs is significantly larger than the number of available multicast groups, the source CDS may dynamically allocate multicast groups to SC content objects, and use the signaling channel to transmits the modifications to multicast group—flow matching, e.g. a source CDS may announce which content objects/SC are to be transmitted next over which multicast addresses. Destination CDS may listen to the signaling channel. Destination CDSs may join or leave multicast addresses according to the flows or content objects they wish to receive. According to embodiments of the invention, destination CDSs may send, possibly in a periodic fashion, a list of the transfers they are listening to. According to embodiments of the invention, additional information may be provided by destination CDSs, for example, the number of bytes received so far on each one of the transfers. According to embodiments of the invention, a destination CDS may choose to listen to a content objects or flows it didn't indicate to the source CDS. According to embodiments of the invention, the feedback transmission period may be dependent on the number of active destination CDSs, and may further be computed such that the source CDS will receive only a few messages per second (an example period would be 15 seconds with 100K destination CDSs). The scheduling algorithms may be designed to work in an unpredicted environments. For example, environments where quality of service (QoS) is unavailable, or where the source side may be unreliable (up/down/busy), hence tight forward scheduling algorithms which rely on reliable and predicted delivery are irrelevant to this scenario.

The scheduling algorithm may assign a flow, a SC or a content object to a multicast address. A scheduling algorithm may consider various parameters, for example, the content audience (e.g. number of destination CDSs currently listening to this SC), required time of arrival, time of waiting for transfer, size of flow and capacity.

According to embodiments of the invention, a scheduling process and/or algorithm may take into account various parameters and/or information. For example, the size of the content to be communicated, an amount of the content already transmitted to destination nodes, a number of destination nodes to which the content is to be delivered or the type of the content. Other exemplary parameters or information that may be considered as part of the scheduling may be available network bandwidth, a network utilization or load indication, for example, one or more parameters indicating congestion, e.g., packets received or dropped at destination nodes, the order of packets received at the destination nodes, etc. Additional information considered may be a delivery deadline associated with the content, a time of day, for example, it may be preferable to communicate content during times when users are not surfing the internet and consequently, the network may be less loaded, a date parameter, a priority parameter associated with the content, and priority parameter associated with at least some of the destination nodes. For example, service level agreement (SLA) parameters may be considered.

According to embodiments of the invention, any relevant metadata associated with the content may be considered as part of a scheduling process or algorithm. Generally, metadata may be any relevant information that is associated with content. Typically, metadata accompanies content, for example, it may be communicated and/or delivered with the content. Metadata may include information and/or parameters such as, but not limited to, a title of a content, a size of a content, a genre, a delivery deadline date and/or time, a rating information etc.

Generally, many different algorithms may be used for scheduling together or separately. Typically, such scheduling algorithms may attempt to adhere to constraints such as mentioned above and fulfill the time of arrival requirement. In accordance with certain embodiments of the present invention, scheduling algorithms may be grouped, by way of non-limiting example, into several scheduling algorithms classes. Some of the classes of algorithms according to the present invention are described below based on manner of handling groups of flows. It will be recognized that other algorithms may be possible within the scope of the present invention.

A first class of algorithms, Class X, may refer to independent flow algorithms: Algorithms in this class may handle each flow independently. In this class, each transfer may be assigned a priority based on characteristics such as the waiting time of a transfer, its size, its prospective audience as well as business considerations and its expiration date. A priority may be set without considering other transfers or flows or the relations or dependencies between flows. The algorithm may maintain a list of all transfers and may further schedule those with highest priority for transmission. There may be several possibilities for deciding when to schedule a transfer, at what rate to do so, and which destinations should be included in a destination group associated with the transfer. Different algorithms may consider such issues differently in order to derive a scheduling priority choosing method. It should be noted that a scheduling timing may affect issues such as the splitting of groups and/or the preemption ability of the algorithm (e.g. stopping a transfer before it completes). Several algorithm classes, according to embodiments of the invention, will be discussed below. Algorithms discussed below may be used by various applications of the present invention.

This class of algorithms may include many possible algorithms differing in scheduling policy and prioritization methods (all of them may try to schedule from the top of their prioritized list of transfers). Possible scheduling policies include: (1) “All or none” algorithm—This algorithm may not start communicating content unless all destinations can receive it. (e.g. a source CDS will not begin a transfer of a content object unless all destination CDSs can receive it); (2) Greedy algorithm—This algorithm may send as much as it can. Its only limitation may be the number of available multicast addresses. This algorithm may send even if only one destination can receive the content sent; (3) Threshold algorithm—This algorithm may start sending a transfer when a certain percentage of the destinations can receive it.

Each of the above mentioned algorithms may also use a wide range of priority setting functions. These functions may include principles such as “the longer a transfer waits, the higher its priority”, or “the closer a transfer is to finishing, the higher its priority”, or “the smaller a transfer is, the higher its priority”, or “the more destinations a transfer has, the higher priority it gets”. This last principle may also consider the capacity of these destinations—“the higher the possible capacity, the higher the priority”. According to embodiments of the invention, the expiration date of a transfer should be a very important factor when setting the priority, especially if the deadline is near. Other business considerations such as the type of channels this transfer belongs to (paid channels, free channels, etc. . . . ) and the type of users which need this transfer may also be considered.

A second class of algorithms, denoted Class 2, may be based on a set of flows. This class of algorithms is a step up in the sense that relations between transfers may be considered. It may be defined most generally as a class of algorithms which give sets of transfers a collective priority, and choose which set of transfers to schedule according to the alternatives proposed and their respective priorities. Here too, there may be many varying parameters. These may include the timing of the scheduling algorithm (when should we schedule, for when should we schedule, and how far into the future should we look), the priority setting function (what associates a set of transfers with a higher priority than another set) and the method of choosing sets alternatives (this method may, in fact, be a key method, as identifying sets within a group of flows may consequently identify priorities).

A simple and intuitive priority cost objective could be to maximize the used capacity of destination CDSs. Assuming transfers aren't cut short, this should indicate that a lot of content will be received by destinations. Using this cost objective, the priority of a set of transfers should be the sum of used bandwidth over all destinations, after putting this set of transfers into play.

The timing of the scheduling algorithm, although interesting, has little affect on the design of the algorithm and can be left as an implementation decision (this doesn't mean it won't have performance effects). Several options for the timing may include: (1) The algorithm may look at a future state where all destinations are completely free. It will choose a set of transfers which should be activated then, but will actually activate them sooner. It may start each transfer when all its designated destinations are ready to receive. (2) Another option is to schedule while considering the system's state at a certain fixed time in the future (e.g. What will things be like in 20 minutes) or at a certain fixed state in the future (e.g. What will things be like when the next 10 transfers finish). (3) For simplicity, one could start by looking at the current state of the system, and wait for things to “free up” before rescheduling. This approach will probably have scheduling performance drawbacks, but can be easily switched to a more intelligent one later on.

We will now propose, by way of non-limiting example, two algorithms from this class which may differ mainly in their method for choosing sets of transfers. The first may do this by using an inefficient exhaustive search, and the second will attempt a slightly more sophisticated (though not necessarily better) method.

An exhaustive search exponential algorithm may consider all possible transfer combinations and chooses the one with the highest priority. It can be visualized as scanning a binary tree of depth n, where n is the number of possible transfers, and each transfer has a level in the tree. Choosing to go right from a specific node means you do not activate this specific transfer, while going left means to include this transfer in the set. Going over all leaves obviously ensures that all possible sets are examined, however—this is extremely costly. A polynomial (even almost linear) in n variation of this algorithm may be obtained, by forcing it to make a decision at each node, and thus eliminating half of the remaining possibilities at each step. First note that the algorithm described above does not fully solve the problem. The output need not be binary in the sense that each transfer can be activated or not. It must also include the rate for each transfer (assuming there is no global rate), and the users designated for each transfer (unless there is a global rule to determine this). However, this abstraction is fairly accurate if a minimal constant global rate is assumed, and if in addition all designated users with enough capacity participate in the transfer. To handle variable receiving rate, after determining as set the algorithm goes over all transfers chosen in the set, in order of decreasing number of designated users, and increase the rate to the maximum possible for each. Another optimization can be to “fill in” remaining multicast addresses (if such exist) in a greedy manner by choosing remaining transfers with many users who can receive them, in a way similar to the greedy algorithm described above.

Going back to the more efficient polynomial scheduling algorithm: it may start from the first transfer and decide whether to include it in a set or not. Actually, a “don't know” verdict, which will postpone the decision to a later time is also allowed. Before taking a decision whether to include a transfer, the algorithm may grade it based on itself and the transfers already added to the set. If this grade is above a predetermined threshold, the transfer will be included in the set. If it is below the threshold, it won't include it, and if it is between these two limits, the verdict will be “don't know”, and the transfer will be placed at the end of the transfer list. If all transfers return a “don't know” verdict, then the limits may be drawn closer to each other. A possible grading function may be the percentage of users who can receive the transfer (possibly dependent upon each user's capacity and membership in other transfers already in the set) from all users interested in the transfer and/or time and speed at which this set of users can receive the transfer. Transfers with large groups of interested users may get substantial bonuses, since a relatively small percentage of a big group may include more users than one hundred percent of a small group.

As discussed in the beginning, several such sets of transfers may be compiled, prioritized, and chosen from. The main difference between these sets may be based upon the initial ordering of the transfers. Here too, several ordering options exist. For example, a simple option may be to order them randomly. Another example is to maintain a rough ordering according to the number of users each transfer has, and to put transfers of large groups up front for some scheduling processes and those of small groups in front for others. Intuitively, putting the large groups first makes sense, because otherwise there may be little chance of scheduling them without splitting them up, on the other hand, many small groups may have disjoint sets of users and could fit together very nicely. A rotation such as the one proposed should be tried to get a feel of the performance effects.

According to embodiments of the invention, optimization may also be provided, for example, by implementing very small groups of transfers (e.g. 2 or 5 transfers) at a time, and grading them as if the best possible combination among this subset was chosen. This would include going over all possible combinations in the subset (exponential number—thus limiting its size).

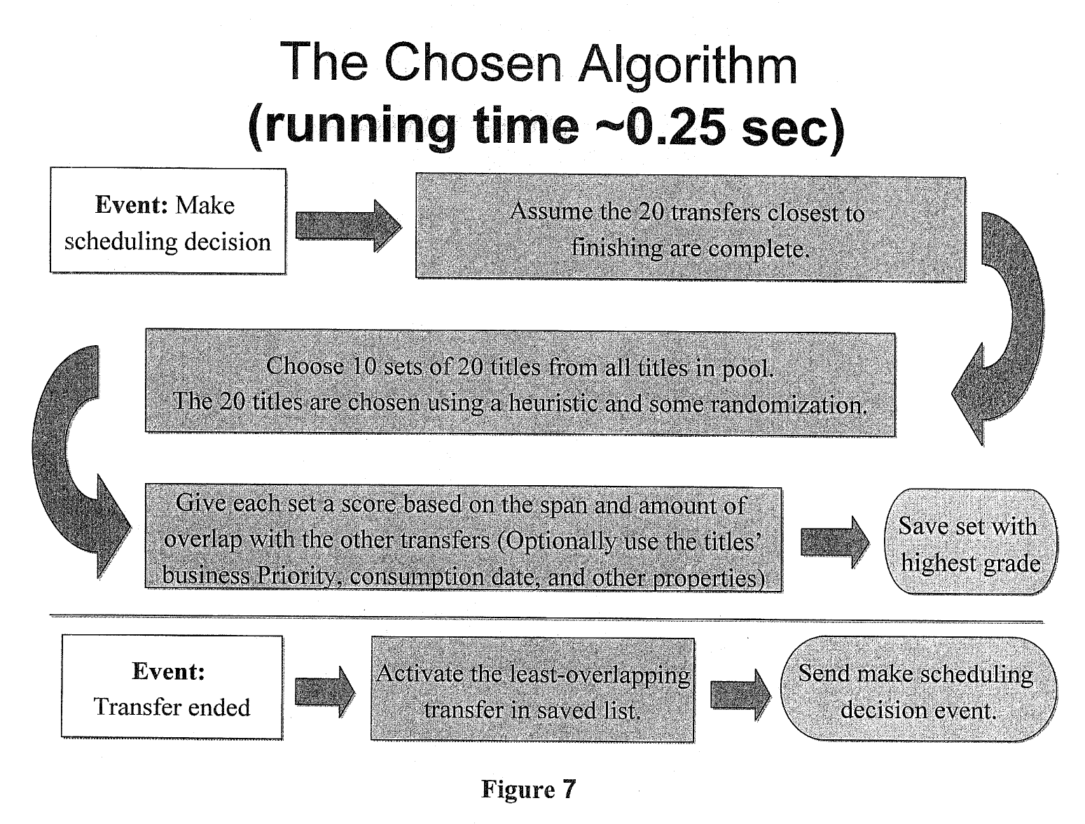

FIG. 7 depicts an example of a scheduling process according to class 2 algorithms.

A third set of algorithms may be denoted Class 3, relating to future planning algorithms. This class may differ from the previous class in the sense that the algorithms in this class may try to order sets of transfers from the present time onwards while taking parameters such as destination, capacity, transfer and time axes into consideration.

A fourth class of algorithms, which may be self taught algorithms, may be denoted Class 4 algorithms. This class may contain algorithms which may derive optimal scheduling parameters according to an environment they are applied to. According to embodiments of the invention, an m-link IS may be responsible for the implementation of link reliability and session maintenance. Noting again the requirement to minimize feedback messages, reliability may be achieved through the use of Forward Error Correcting Codes (FEC). According to embodiments of the invention, a destination CDSs may send only periodic feedback messages indicating how many bytes from current active transfers it has already recovered and/or received. Depending on the scheduling algorithm, a source CDS may determine to terminate a transfer after a “predefined threshold” of destination CDSs who received a predefined portion of the transfer is reached. The reasoning behind this may be that if enough destinations have already indicated transfer completion, then there's a high probability that other destinations have already completed the transfer, yet have not reached the periodic reporting time.

Due to, for example, congestion, or temporary link failure, m-link destinations may lose parts of content objects transmitted by an m-link source CDS. CDSs may mitigate the effects of such loss by the usage of FEC. A FEC may enable recovery from packet loss (this is enabled, for example, by erasure codes). According to embodiments of the invention, m-link destination CDSs may use FEC to recover pieces of information they didn't receive. Such recovery may be achieved based on redundant information inserted according to FEC into the blocks that were receive. Note that each destination CDS might receive a different subset of a content object's blocks, yet FEC may enable a receiver to recover missing blocks, from a subset of blocks it did receive, provided enough blocks were received. There are several known erasure FECs known in the literature which may be used in this scenario, e.g. Reed-Solomon codes.

According to embodiments of the invention, an IS associated with an m-link may detect, and recover from, link congestions. Congestion control may be destination based, source based or network based. According to embodiments of the invention, congestion control may be destination-based. According to embodiments of the invention, a possible way for an m-link destination to handle congestion may be by trying to detect congestion, and force transmission abort by leaving one or more of the multicast groups on which it currently receives flows. According to embodiments of the invention, a destination CDS may decrease the number of multicast groups it listens too according to a percentage of packet/blocks loses it experiences. According to embodiments of the invention, detecting packet/block loses may be accomplished by observing sequence numbers which may be associated with packets and/or blocks transmitted, for example, as part of a FEC protocol used.

As described above, CE 2 may assume the responsibility for the construction of a CDO. A CDO may be viewed as a hyper graph containing a set of CDGs. A set of vertices of a CDO may contain all the CDSs which are part of a CDO (a CDG may be configured to be a part of a CDO, possibly by the relevant MEs 3). A CDG may contain a set of root CDSs, a set of destination CDSs (which may be CDSs subscribed to the SC corresponding to the CDG), and a set of intermediate CDS and virtual links such that there is a set of directed routes leading from some root (or from clusters of roots, if redundancy is desired), to all the destinations.

According to embodiments of the invention, CE 2 may use known graph algorithms that appear in the literature in order to find, for each CDG, a set of directed routes spanning all the CDSs in it.

A CDO may be viewed as a hyper graph, whose vertex set consists of all the vertex sets of all the CDGs corresponding to a SC it supports. A CDO may contain a hyper-edge of type x (which could be m-link, p-link or u-link) if there is at least one edge of type x connecting two vertices in one of the CDGs in the CDO.

It should be noted that a CDG in general may have several roots even with the same content owner. For example: Disney may distribute the same content object (title) through multiple entry points, for example due to different release windows.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Those skilled in the art will readily appreciate that the system according to the invention, may be a suitably programmed computer Likewise, the invention contemplates a computer program being readable by a computer for executing the method of the invention. The invention further contemplates a machine-readable memory tangibly embodying a program of instructions executable by the machine for executing the method of the invention.

It is also to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception, upon which this disclosure is based, may readily be utilized as a basis for designing other structures, methods, and systems for carrying out the several purposes of the present invention.

Those skilled in the art will readily appreciate that various modifications and changes can be applied to the embodiments of the invention as hereinbefore described without departing from its scope, defined in and by the appended claims.

What is claimed is:

1. An apparatus to deliver content comprising:
at least one network interface to:
receive content objects from a content source, and
receive requests for content from a plurality of nodes;
a storage device to store said content objects; and
a scheduling module to:
determine respective times to send said content objects from said storage device based at least in part on said requests, and
cause said at least one network interface to send said content objects using a multicast communication protocol based on said determined time.

2. The apparatus of claim 1, wherein said scheduling module is to further determine said respective times to send said content objects based at least in part on at least one parameter selected from parameters consisting of: network resources, available bandwidth, a size of said content object, a delivery deadline associated with said content object, a number of destination nodes to which said content object is to be sent, available multicast groups, and a plurality of priority levels respectively associated with said content objects.

3. The apparatus of claim 1, wherein said scheduling module is further configured to dynamically associate a parameter of at least one multicast group with a respective one of said content objects, and to cause said at least one network interface to send said content object to destination nodes based on said multicast group parameter.

4. The apparatus of claim 3, wherein said scheduling module is further to cause said at least one network interface to send said associated parameter to said nodes.

5. The apparatus of claim 1,
wherein at least a portion of said requests is associated with a store channel,
wherein at least a portion of said content objects is associated with a store channel,
wherein said scheduling module is to further determine said respective times to send said content objects based at least in part on a number of requests for a store channel matching the store channel of said content objects.

6. The apparatus of claim 1,
wherein at least a portion of said requests is associated with a flow of content objects,
wherein at least a portion of said content objects is associated with a flow of content objects,
wherein said scheduling module is to further determine said respective times to send said content objects based at least in part on a number of requests for a flow of content objects matching the flow of content objects associated with said content objects.

7. The apparatus of claim 1, wherein said content objects are received according to a unicast communication protocol.

8. The apparatus of claim 1, wherein said content objects are received according to a broadcast communication protocol.

9. The apparatus of claim 1, wherein said apparatus is to transmit a first portion of said content objects according said multicast communication protocol, and based on a predetermined condition, to transmit a second portion of said content objects according to a second communication protocol different from said multicast communication protocol.

10. The apparatus of claim 9, wherein said apparatus is configured to select said second communication protocol based on at least one parameter selected from the group consisting of: an amount of said content objects for transmission, an amount of said content objects previously transmitted, a number of requests associated with said content objects, and a network resource availability parameter.

11. The apparatus of claim 9, wherein said second communication protocol is peer-to-peer communication protocol.

12. The apparatus of claim 11, wherein said apparatus serves as a seed for transmission of said content objects using said peer-to-peer protocol.

13. The apparatus of claim 1, further configured to send a feedback message to said content source, wherein said feedback message indicates at least an identifier of content object, an indication of an amount of said content object cumulatively received from said source, and a measure of available storage capacity.

14. The apparatus of claim 1, wherein said apparatus is further configured to receive from a destination node a feedback message associated with transmission of said content object, wherein said feedback message indicates at least an identifier of content object at said destination node, an indication of an amount of said content object cumulatively received at said destination node, and a measure of an available storage capacity at said destination node.

15. The apparatus of claim 14, further configured to perform an action based on said feedback message, wherein said action is selected from a list consisting of: modifying a time to send said content object, aborting sending of said content object, and selecting an alternative communication protocol for sending said content objects.

16. The apparatus of claim 1, further configured to monitor a communication congestion parameter and according to a value of said communication congestion parameter to discontinue reception of said content object.

17. A method of delivering content comprising:
receiving requests for content from a plurality of nodes;
receiving content objects from a content source;
storing said content objects;
determining respective times to send said content objects based at least in part on said requests; and
based on said determined time, sending said content objects using a multicast communication protocol.

18. The method of claim 17, wherein said determining respective times to send said content objects is based at least in part on at least one parameter selected from a group of parameters consisting of: a network resource parameter, available bandwidth, a size of a content object, a delivery deadline associated with a content object, a number of destination nodes to which a content object is to be sent, available multicast groups, and a priority level associated with a content object.

19. The method of claim 17, further comprising dynamically associating a parameter of at least one multicast group with a plurality of content objects, and further comprising sending said plurality of content objects to destination nodes based on said multicast group parameter.

20. The method of claim 19, further comprising sending said parameter of at least one multicast group to at least some of said destination nodes.

21. The method of claim 17,
wherein at least a portion of said requests is associated with a store channel,
wherein at least a portion of said content objects is associated with a store channel,
wherein said determining respective times to send said content objects is based at least in part on a number of requests for a store channel matching the store channel of said content objects.

22. The method of claim 17,
wherein at least a portion of said requests is associated with a flow of content objects,
wherein at least a portion of said content objects is associated with a flow of content objects,
wherein said determining respective times to send said content objects is based at least in part on a number of requests for a flow of content objects matching the flow of content objects of said content object.

23. The method of claim 17, wherein said receiving content objects from a content source is according to a unicast communication protocol.

24. The method of claim 17, wherein said receiving content objects from a content source is according to a broadcast communication protocol.

25. The method of claim 17, further comprising transmitting a first portion of said content objects according said multicast communication protocol, and based on a predetermined condition, transmitting a second portion of said content objects according to a second communication protocol different from said multicast communication protocol.

26. The method of claim 25, further comprising selecting said second communication protocol based on at least one parameter selected from the group consisting of: an amount of said content objects for transmission, an amount of said content objects previously transmitted, a number of requests associated with said content objects, and a network resource availability parameter.

27. The method of claim 25, wherein said second communication protocol is a peer-to-peer communication protocol.

28. The method of claim 27, further comprising serving as a seed for transmission of said content objects using said peer-to-peer protocol.

29. The method of claim 17, further comprising sending a feedback message to said content source, wherein said feedback message indicates at least an identifier of a content object, an indication of an amount of said content objects cumulatively received from said source, and a measure of available storage capacity.

30. The method of claim 17, further comprising receiving from a destination node a feedback message associated with a transmission of said content objects, wherein said feedback message indicates at least an identifier of a content object, an indication of an amount of said content object cumulatively received at said destination node, and a measure of an available storage capacity at said destination node.

31. The method of claim 30, further comprising performing an action based on said feedback message, wherein said action is selected from a list consisting of: modifying a time to send a content object, aborting sending of a content object, and selecting an alternative communication protocol for sending a content object.

32. The method of claim 17, further comprising monitoring a communication congestion parameter and according to a value of said communication congestion parameter discontinuing a reception of said content objects.

33. An apparatus to deliver content comprising:
at least one network interface to:
receive content objects from a content source, and
receive requests for content from a plurality of nodes;
a storage device to store said content objects; and
a scheduling module to:
determine respective times to send said content objects from said storage device based at least in part on said requests, and
cause said at least one network interface to send said content objects based on said determined time,
wherein said network interface is further to receive feedback messages from said plurality of nodes receiving said content objects, and
wherein said scheduling module is to modify said respective times to send said content objects based on said received feedback messages.

34. The apparatus of claim 33, wherein said scheduling module is to further determine said respective times to send said received content objects based at least in part on at least one parameter selected from a parameters group consisting of: a network resource parameter, available bandwidth, a size of a received content object, a delivery deadline associated with a received content object, a number of destination nodes to which said received content object is to be sent, available multicast groups, and a priority level associated with a received content object.

35. The apparatus of claim 33, wherein said network interface is to send said content objects using a broadcast communication protocol.

36. The apparatus of claim 33, wherein said network interface is to send said content objects using a multicast communication protocol.

37. The apparatus of claim 33, wherein said apparatus is to transmit a first portion of said received content object according to a first communication protocol, and based on a predetermined condition, to transmit a second portion of said received content object according to a second communication protocol different from said first communication protocol.

38. The apparatus of claim 37, wherein said apparatus is configured to select said second communication protocol based on said received feedback messages.

39. The apparatus of claim 38, wherein said feedback messages indicate at least one of: a content object identifier, an indication of an amount of said content object cumulatively received, and a measure of available storage capacity.

40. The apparatus of claim 33, further configured to perform an action based on said feedback messages, wherein said action is selected from a list consisting of: aborting sending of a received content object, and selecting an alternative communication protocol for sending a content object.

41. The apparatus of claim 33, wherein said feedback messages comprise a communication congestion parameter, and wherein said scheduling module is to discontinue reception of said content objects according to a value of said communication congestion parameter.

42. A method of delivering content comprising:
receiving requests for content from a plurality of nodes;
receiving content objects from a content source;
storing said content objects;
determining respective times to send said content objects based at least in part on said requests;
sending said content objects to a plurality of nodes based on said determined time;
receiving at least one feedback message from said plurality of nodes; and
modifying said respective times to send said content objects based on said received at least one feedback message.

43. The method of claim 42, wherein determining said respective times to send said received content objects is based at least in part on at least one parameter selected from a parameters list consisting of: a network resource parameter, available bandwidth, a size of a received content object, a delivery deadline associated with said received content objects, a number of destination nodes to which a received content object is to be sent, available multicast groups, and a priority level associated with said received content objects.

44. The method of claim 42, wherein said sending said content objects to a plurality of nodes is according to a broadcast communication protocol.

45. The method of claim 42, wherein said sending said content objects to a plurality of nodes is according to a multicast communication protocol.

46. The method of claim 42, further comprising transmitting a first portion of said content objects according to a first communication protocol, and based on a predetermined condition, transmitting a second portion of said content objects according to a second communication protocol different from said first communication protocol.

47. The method of claim 46, further comprising selecting said second communication protocol based on at least one received feedback message.

48. The method of claim 47, wherein said feedback messages comprises at least one of: a content object identifier, an indication of an amount of content objects cumulatively received, and a measure of available storage capacity.

49. The method of claim 42, further comprising performing an action based on said at least one feedback message, wherein said action is selected from a list consisting of: aborting sending of a content object, and selecting an alternative communication protocol for sending a content object.

50. The method of claim 42, wherein said at least one feedback message comprises a communication congestion parameter, and further comprising discontinuing sending of content objects according to a value of said communication congestion parameter.
